(19) United States
(12) Patent Application Publication
(10) Pub. No.: US 2026/0110846 A1
(43) Pub. Date: Apr. 23, 2026

(54) LC CONNECTOR FOR HOLLOW-CORE OPTICAL FIBERS

(71) Applicant: Samba Photonics Lab Inc., Irvine, CA (US)

(72) Inventors: Xiaolin Tong, Irvine, CA (US); Xiaotian Steve Yao, Las Vegas, NV (US); Danshu Rao, Beijing (CN)

(21) Appl. No.: 18/919,359

(22) Filed: Oct. 17, 2024

(51) Int. Cl. G02B 6/32; G02B 6/02; G02B 6/35

(52) U.S. Cl. CPC G02B 6/32; G02B 6/02304; G02B 6/3588

(57) ABSTRACT

A hollow-core fiber connector assembly and the process assembling thereof are disclosed. The assembly includes a Gradient-Index (GRIN) fiber, a GRIN stub and a short segment of GRIN fiber, a hollow-core fiber holder (HCF holder) to securely hold and align the hollow-core fiber with the GRIN stub, the hollow-core fiber to guide the light through its hollow core, reducing optical losses and dispersion compared to solid-core fibers; and a metal hub encasing the assembly, providing structural protection and enhancing durability.

### BACKGROUND OF THE INVENTION

Hollow-core optical fibers (HCFs) represent a significant advancement in fiber-optic technology, offering distinct advantages over traditional solid-core fibers. These fibers guide light primarily through a hollow air core, which greatly reduces the interaction between light and the fiber material. As a result, HCFs exhibit lower attenuation, minimal nonlinearity, and higher power handling capabilities compared to standard single-mode fibers (SMFs). Recent innovations, such as the development of double nested anti-resonant node-less fiber (DNANF) structures, are exemplary of the advantages of HCFs. These attributes make HCFs ideal for a wide range of applications, including fiber-optic communications, high-power laser delivery, interferometry, gas sensing, and gas lasers.

As the use of HCFs expands in various high-performance applications, there is an increasing demand for reliable and efficient connectivity solutions. Connectors play a crucial role in the practical deployment of optical fiber systems, ensuring minimal signal loss and maintaining the integrity of the transmitted data. However, the unique properties of HCFs, such as their specialized guiding mechanisms and structural characteristics, present challenges that conventional fiber connectors are not equipped to handle. This underscores the need for developing new types of connectors specifically designed to meet the requirements of HCFs.

As a result, there is a critical need for developing a specialized Lucent Connector (LC connector) specifically designed for HCFs. Such a connector would need to address the precise alignment requirements and minimize insertion losses. The development of this technology is essential for unlocking the full potential of HCFs in advanced optical systems.

### BRIEF SUMMARY OF THE INVENTION

The present application proposes an LC Connector for hollow core connectors which provides at least the following features and advantages:
1. High Precision Alignment: The use of a GRIN Stub and HCF Holder ensures precise alignment of the hollow-core fiber (HCF) with the incoming light, which is crucial for minimizing insertion losses and maximizing optical performance.
2. Efficient Light Coupling: The GRIN-Fiber at the front of the assembly efficiently focuses and couples light into the HCF, enhancing the overall coupling efficiency and reducing potential losses.
3. Enhanced Durability: The Metal Hub encases the entire assembly, offering robust sealed structural protection and ensuring the long-term durability and stability of the optical connection.
4. Design for Mass Production: The use of adhesive to secure the GRIN Stub and HCF Holder simplifies the assembly process while ensuring stable and reliable alignment.
5. Cost Competitive Design: The competitive cost of the HCF connector is due to the use of common parts available on the market, which reduces manufacturing expenses and makes the connector more affordable.

The present application relates to a hollow-core fiber connector assembly designed to efficiently couple light into a hollow-core optical fiber. The assembly comprises several key components including a Gradient-Index (GRIN) fiber positioned at the front end of the assembly. The GRIN fiber focuses and couples light into the hollow-core fiber, providing precise light transmission.

Further may be included in the assembly are GRIN stub and GRIN fiber segment that include a short segment of GRIN fiber, and a GRIN stub are utilized to fine-tune the alignment and focus of the light before it enters the hollow-core fiber. This setup enhances the initial alignment and reduces losses.

Further may be included in the assembly is hollow-core fiber holder (HCF holder). The HCF holder is designed to securely hold and align the hollow-core fiber with the GRIN stub, ensuring stable and precise light guidance.

Further may be included in the assembly is hollow-core fiber. This component guides the light through its hollow core, which reduces optical losses and dispersion compared to conventional solid-core fibers, making it ideal for high-performance applications.

Further may be included is a metal hub. The entire assembly is encased in a metal hub, which provides structural protection and enhances the durability of the connector.

Additional feature of the disclosure may include single mode fiber (SMF) splicing. The GRIN fiber can be spliced with a single mode fiber for better compatibility and light coupling.

Further additional feature may include active coupling process. The second alignment between the GRIN stub and the HCF holder is achieved through an active coupling process, ensuring optimal light transmission through the hollow-core fiber.

Further additional feature may include optical coating. The end face of the GRIN stub may be coated with an optical coating to improve light coupling efficiency and overall performance.

Further additional feature may include adhesive securing. The GRIN fiber, GRIN stub, and HCF holder are secured in place using adhesive, maintaining precise alignment throughout the assembly.

The assembly may provide improved light coupling and reduced losses, making it highly suitable for applications requiring precise optical alignment and high-quality signal transmission.

The present application discloses an apparatus, method and system of hollow-core fiber connector assembly designed to optimize light transmission and reduce optical losses of the connector. This assembly features a Gradient-Index (GRIN) fiber at its front end, which is specifically configured to focus and couple light into the hollow-core fiber. The assembly includes a GRIN stub and a short segment of GRIN fiber, allowing for fine-tuning of the light's alignment and focus before entering the hollow-core fiber. A hollow-core fiber holder (HCF holder) securely maintains the alignment of the hollow-core fiber with the GRIN stub, enabling efficient light guidance through the fiber's hollow core, thus minimizing dispersion compared to conventional solid-core fibers.

Further enhancements include the option to splice a Single Mode Fiber (SMF) with the GRIN fiber and the implementation of an active coupling process for second alignment of the GRIN stub with the HCF holder, ensuring optimal light transmission. The end face of the GRIN stub can be coated with an optical coating to improve light coupling performance. The assembly is structurally encased in a metal hub, which not only provides durability but also serves as a protective support tube, ensuring long-term stability and reliability of the optical connection.

### BRIEF DESCRIPTION OF THE DRAWINGS

FIG. 1 is a perspective view of the HCF connector core assembly according to an example of the present application.

FIG. 2 is a cross-sectional view of the HCF connector core assembly according to an example of the present application.

FIG. 3 is a blown-up illustration of the cross-sectional view of the GRIN fiber in the connector core assembly according to an example of the present application.

FIG. 4 is a cross-sectional view of the GRIN fiber with superimposed gradient refractive index profile of the GRIN fiber according to an example of the present application.

FIG. 5 illustrates key aspects of the assembling HCF connector core assembly in view of its core structure according to an example of the present application.

FIG. 6 is a perspective view of an exemplary LC connector for HCF with the core assembly according to an example of the present application.

FIG. 7 is a cross-sectional view of the exemplary LC connector for HCF with the core assembly according to an example of the present application.

FIG. 8 is an exploded view of the exemplary LC connector for HCF with the core assembly according to an example of the present application.

FIGS. 9-1 and 9-2 illustrate the assembling steps of the connector core assembly and the exemplary connector according to examples of the present application

### DETAILED DESCRIPTION OF THE INVENTION

The following detailed description of the present application refers to the accompanying drawings, which form a part hereof and show, by way of illustration, specific embodiments in which the present application may be practiced. These embodiments are described in sufficient detail to enable those skilled in the art to practice the present application, and it is to be understood that other embodiments may be utilized and that structural changes may be made without departing from the scope of the present application.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

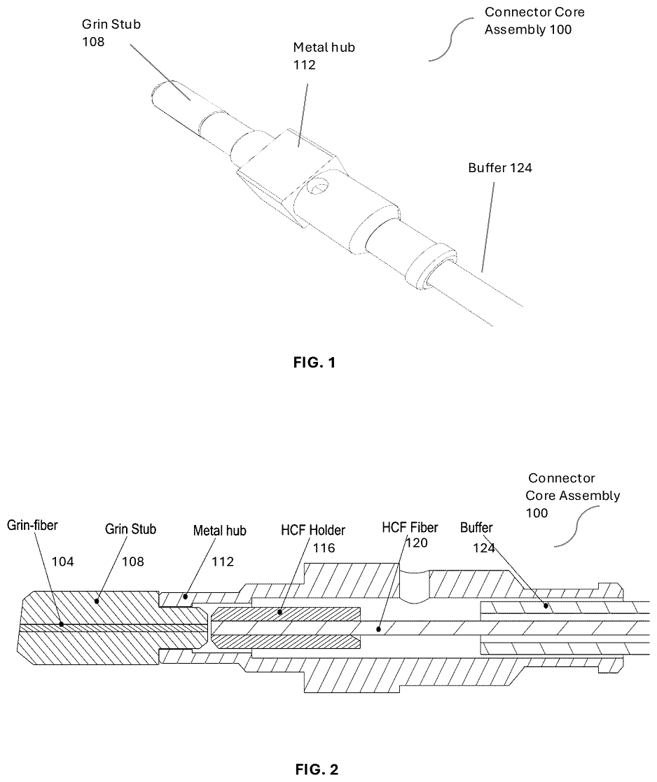

FIG. 1 is a perspective view of the HCF connector core assembly 100 according to an example of the present application. Referring to FIG. 1, the perspective view of the HCF connector core assembly 100 shows an HCF buffer 124 that contains the HFC fiber is connected to the metal hub 112 of the core assembly 100 on one side. A Gradient-Index (GRIN) stub 108 that holds the GRIN fiber is connected to the metal hub 112 from the other end.

FIG. 2 is a cross-sectional view of the HCF connector core assembly 100. Referring to FIG. 2, the core assembly 100 includes a Gradient-Index (GRIN) fiber 104 located at the front end of the core assembly 100. The GRIN fiber 104 is responsible for efficiently focusing and coupling light into the HCF. The GRIN stub 108 is a short segment of GRIN fiber 104 used for fine-tuning the light alignment and focus before entering the HCF. The HCF holder 112 securely holds the HCF and ensures proper alignment with the GRIN stub 108. The HCF fiber 116 guides light through its hollow core, reducing losses and dispersion compared to solid-core fibers. The metal hub 120 is a protective support tube that encases the core assembly 100, providing structural protection after the components that have been aligned and fixed. The buffer 124 is a protective layer surrounding the HCF, offering additional mechanical stability within the core assembly 100.

The coupling process using the core assembly 100 begins by actively coupling the GRIN stub 108 with the HCF holder 112 that contains the HCF fiber 116. This active coupling ensures precise alignment, which is critical for optimal light transmission. Once aligned, the GRIN stub 108 and HCF holder 116 are secured in place using adhesive. Finally, the metal hub 120 is used as a protective support tube to encase and protect the assembly, ensuring long-term stability and durability of the optical connection.

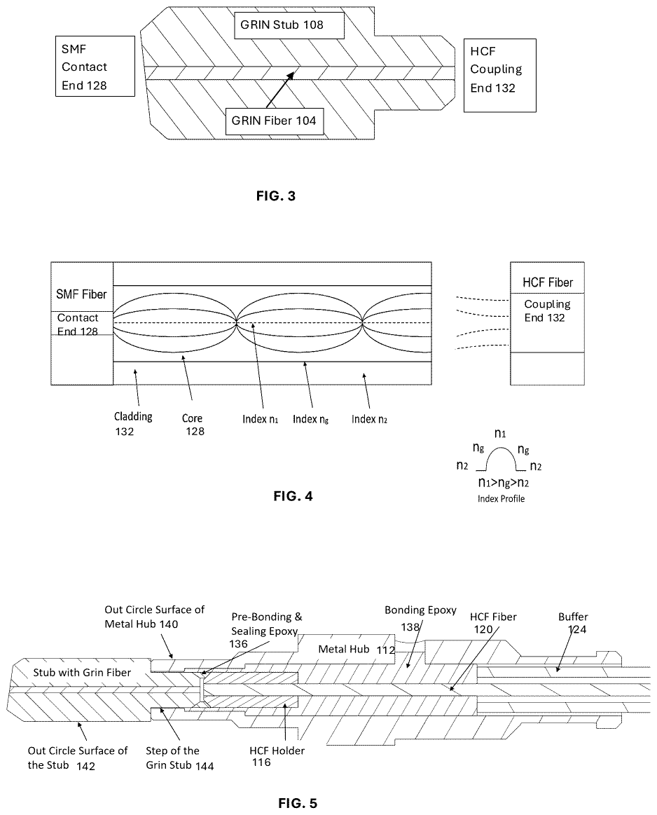

FIG. 3 is a blown-up illustration of the cross-sectional view of the GRIN fiber 104 in the core assembly 100. According to one example of the present application, the GRIN fiber 104 held inside of the GRIN stub 108 couples the optical beam between the HCF fiber via the HCF coupling end 132 and the single mode fiber (SMF) fiber via the SMF fiber contact end 128.

FIG. 4 illustrates a cross-sectional view of the GRIN fiber 104 with superimposed gradient refractive index profile of the GRIN fiber 104. The gradient refractive index profile allows light rays to continuously bend toward the fiber's axis as they propagate, thereby minimizing signal dispersion and enhancing optical performance. Referring to FIG. 4, the fiber core 128 of the GRIN fiber 104 has the highest refractive index n₁ which facilitates efficient light guidance. The cladding 132 of the GRIN fiber 104 has the lowest refractive index n₂, ensuring confinement of the light within the fiber core 128.

The refractive index n_{g} reduces between the fiber core 128 and the cladding 132, which satisfies the inequality n₁>n_{g}>n₂. According to one example, the refractive index n_{g} reduces in a non-linear fashion as illustrated in FIG. 4. This refractive index profile as described supports the transmission of multiple light modes with reduced distortion, making the GRIN fiber 104 ideal for high-bandwidth, long-distance communication applications. The gradual refractive index transition also reduces internal reflection losses and improves overall signal quality.

The GRIN fiber 104 is positioned at the front of the core assembly 100 and is responsible for focusing and coupling light into the HCF. The unique characteristic of the GRIN fiber 104 is its varying refractive index, which gradually changes from the fiber core center of to the cladding of the GRIN fiber 104. This gradient allows the light to follow a curved path within the fiber, enabling the optical beam to be focused on a specific point.

As illustrated in FIGS. 2 and 3, GRIN stub 108 holds a short segment of the GRIN fiber 104 and plays a critical role in the alignment and focus of the light beam before it enters the HCF. For mass manufacturing, the GRIN Stub 108 is polished to a length slightly longer than the standard 1.25 pitch, such as a 1.29 pitch. As the optical beam exits the GRIN Stub 108, it gradually reaches a focal point at a distance (referred to as the “gap”) where it achieves a flat phase. With the length of GRIN Stub 108 designed as such, the Mode Field Diameter (MFD) of the beam is matched with that of the HCF at this focal point, ensuring a low-loss connection.

GRIN fiber 104 and GRIN Stub 108 work together to control the beam's MFD and phase, ensuring optimal light transmission into the HCF with minimal loss, even with a small gap between the components. The precise design of the GRIN Stub's length and polishing ensures that the optical beam focuses at the correct point, matching the MFD of the HCF and facilitating a low-loss optical connection.

GRIN Stub 108 can be coated with an optical coating to enhance light coupling and improve performance. The 1.29 pitch of GRIN fiber 104 can also be replaced by an SMF spliced with a GRIN fiber, and the length of the Grin fiber can instead be 0.29 pitch.

To achieve the advantages of the present application described throughout application, various treatment of the HCF fiber 120 may be applied. Those advantages of the treatment may be readily appreciated by a skilled artisan in conjunction with the HCF connector core assembly 100's core structure.

FIG. 5 illustrates key aspects of the assembling HCF connector core assembly 100 in view of its core structure. Referring to FIG. 5, the HCF fiber 120 is mechanically cleaved and then bonded in the HCF holder 116 to ensure the end face of the HCF fiber 120 will not affect the optical transmission performance. And there will be a buffer 124 out of the HCF to provide the mechanical protection from the environment.

HCF sealing is applied to protect the HCF fiber 120 from external environmental factors that could degrade its performance, such as dust, moisture, and mechanical stress. For example, pre-bonding and sealing epoxy can be applied at 136 outside of the coupling surface between the coupling ends of the HCF holder 116 and GRIN stub 108 (as indicated in connection with FIGS. 2-3). According to a preferred example, epoxy may not be applied therein between the GRIN Stub 108 and HCF holder 116 for the inner sealing of the core structure of the connector core assembly 100. Keeping the epoxy out of the coupling surface ensures that the optical beam transmitted in via the hollow core of the HCF fiber directly couples to the coupling end of the GRIN fiber 104. According to one example, a coating is applied at the coupling end of the GRIN stub 108.

Further, bonding epoxy 138 may be applied in the metal hub 112 to provide outer sealing for the core structure of the connector core assembly 100. The inner and out sealing give mechanical support to the connector core, which generally includes the optical components such as the optical fibers their ancillary parts for coupling the optical beams transmitted through the connector. The alignment of the connector core is critical.

In one example, metal hub 112 and GRIN stub 108 are the major components of the connector core. The out-circle surface of the GRIN stub 142 may be the same as the present industry standard LC Ferrule, to ensure the optical connection performance. There may be a step of the GRIN Stub 144, a feature provided at the HCF coupling end of the GRIN Stub 108. The step 144 may be bonded with the metal hub 112 and the out-circle surface of the metal hub 140 may be smaller than the GRIN stub 108 to avoid the overlap between the connector core and a sleeve that may be provided. According to one example of the present application, there an epoxy injection hole may be made on the metal hub 112, the bonding epoxy 138 may be infilled into the metal, bundling the HCF holder 116 with the HCF fiber 120, the metal hub 112 and the GRIN stub 108 together.

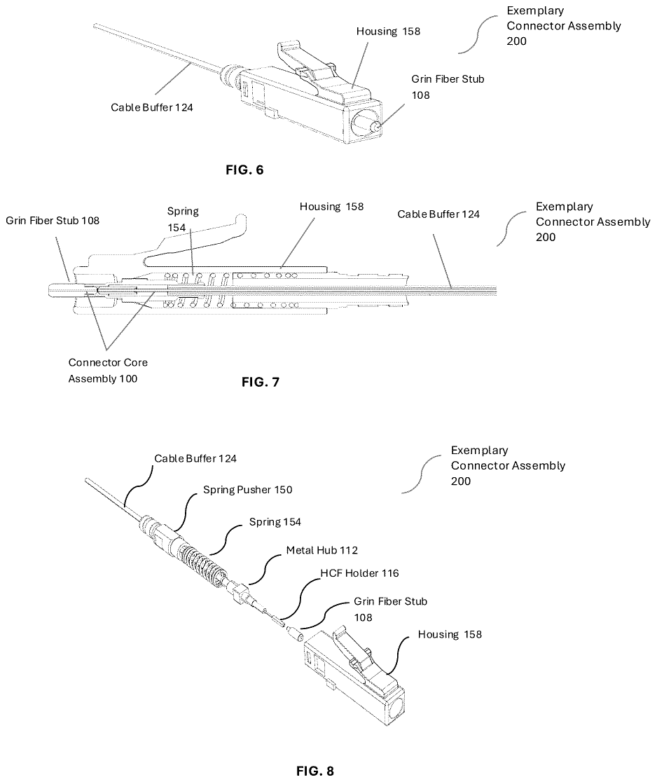

The feature of the connector core assembly 100 may be used in different connector by changing the metal hub outer features. FIG. 6 is a perspective view of an exemplary LC connector for HCF with the core assembly described above. FIG. 7 is a cross-sectional view of the exemplary LC connector. FIG. 8 is an exploded view of the exemplary LC connector. Referring to FIG. 6, from the perspective view of the exemplary connector 200, a housing 158 is illustrated therein. The outer end (the end that to be coupled to the SMF contact ends 128 as illustrated in FIGS. 3-4) of the GRIN stub 108 is exposed on one end of the perspective view of the exemplary connector 200. Cable buffer 124 can be seen on the opposite end of the exemplary connector 200 in the perspective view. The connector core assembly 100 mostly hidden inside of the housing 158.

As illustrated in the cross-sectional view of the exemplary connector 200 in FIG. 7, the connector core assembly 100 is hidden inside of the housing 158. The outer end of the GRIN stub 108 is exposed on one end of the perspective view of the exemplary connector 200. Cable buffer 124 can be seen on the opposite end of the exemplary connector 200 in the perspective view. The connector core assembly 100 mostly hidden inside of the housing 158. A spring 154 of a spring mechanism is added to the assembly to secure the connector core assembly 100 within the housing 158. According to one example, the spring mechanism removably recures the connector core assembly 100 therein.

In the exploded view of the exemplary connector 200, the components of the hidden connector core assembly 100 is shown therein. The cable buffer 124, metal hub 112, HCF holder 116, GRIN stub 108 of the connector core assembly 100 are illustrated in the exploded view. The spring mechanism includes a spring pusher 150 and the spring 154 are inserted outside of the connector core assembly 100. The housing 158 of the exemplary connector 200 is illustrated at the near end of the exploded view.

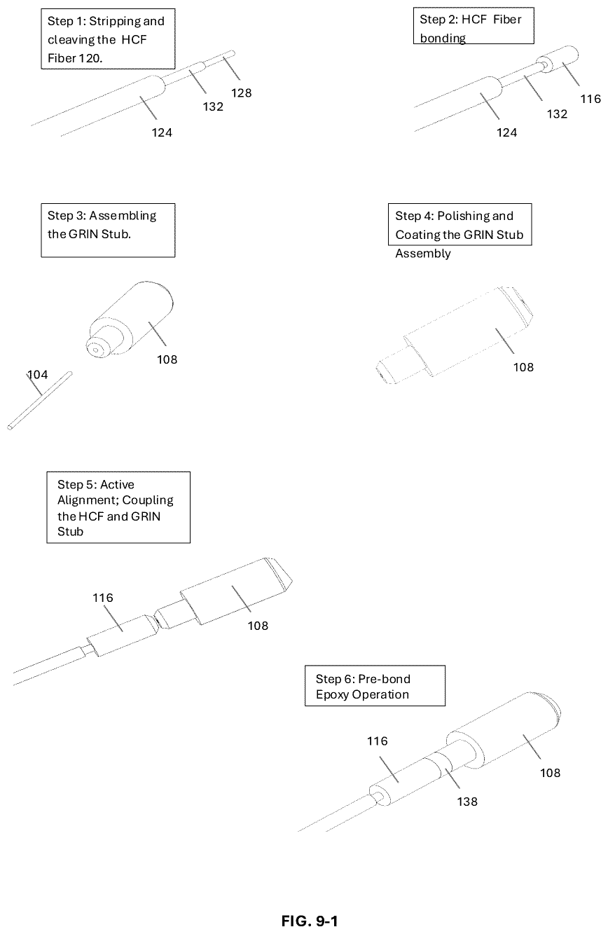

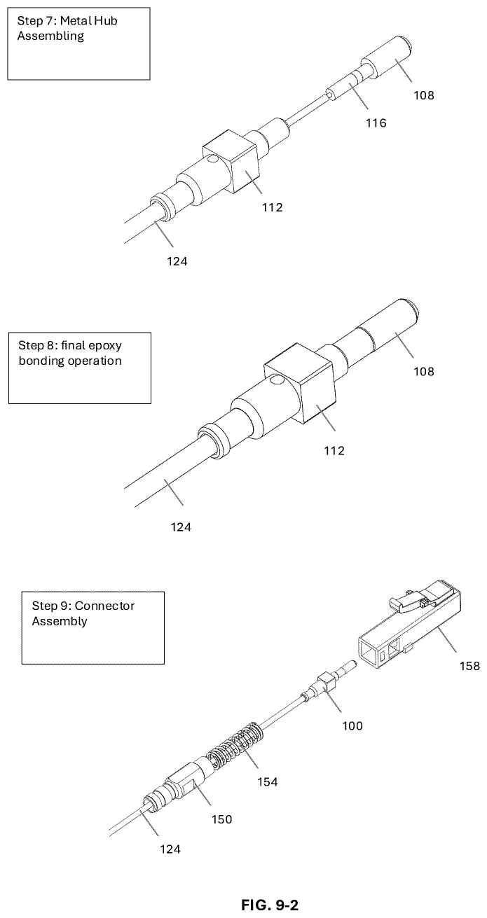

FIGS. 9-1 and 9-2 illustrate the assembling steps of the connector core assembly 100 and the exemplary connector 200 according to examples of the present application. Referring to FIG. 9-1, nine steps are illustrated of the assembling process. In Step 1, the HCF cable is stripped and cleaved, exposing the buffer 124, cladding 132 and fiber core 128 as illustrated therein. In Step 2, the stripped and cleaved HCF fiber is bonded to HCF holder 116 as illustrated therein. In Step 3, the GRIN fiber 104 is assembled with GRIN stub 108 as illustrated therein. In Step 4, the assembled GRIN stub 108 is polished and coating may be applied. In Step 5, the HCF fiber 120 held within the HCF holder 116 is actively aligned with the GRIN fiber 104 held by the GRIN stub 108. In Step 6, pre-bond epoxy 138 is applied between the HCF holder 116 and the GRIN stub 108.

Referring to FIG. 9-2 in Step 7, the metal hub 112 is assembled to the aligned and pre-bonded HCF holder 115 and GRIN stub 108. According to the example shown in FIG. 9-2, the metal hub 112 passes through the buffer 124 in the assembling step. In Step 8, final epoxy bonding is provided. After this step, the connector core assembly 100 is completed. In Step 9, the exemplary connector 200 is assembled. The spring 154 and spring pusher 150 are assembled on the buffer 124. The spring mechanism pushes the connector core assembly 100 into the housing 158 and removably secures the connector core assembly 100 inside of the housing 158.

Skilled artisan will appreciate at least the following advantages of the present application:
1. High Precision Alignment: The use of a GRIN Stub and HCF Holder ensures precise alignment of the hollow-core fiber (HCF) with the incoming light, which is crucial for minimizing insertion losses and maximizing optical performance;
2. Efficient Light Coupling: The GRIN-Fiber at the front of the assembly efficiently focuses and couples light into the HCF, enhancing the overall coupling efficiency and reducing potential losses;
3. Enhanced Durability: The Metal Hub encases the entire assembly, offering robust sealed structural protection and ensuring the long-term durability and stability of the optical connection;
4. Design for Mass Production: The use of adhesive to secure the GRIN Stub and HCF Holder simplifies the assembly process while ensuring stable and reliable alignment; and
5. Cost Competitive Design: The competitive cost of the HCF connector is due to the use of common parts available on the market, which reduces manufacturing expenses and makes the connector more affordable.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. The embodiments described are not intended to be exhaustive or to limit the present application to the precise forms disclosed. Rather, they are chosen and described to best explain the principles of the present application and its practical applications, thereby enabling others skilled in the art to utilize the present application in various embodiments and with various modifications as are suited to the particular use contemplated. This application is intended to cover any adaptations or variations of the specific embodiments discussed herein. Therefore, it is intended that this disclosure be limited only by the claims and the equivalents thereof, and not by the specific examples given. The scope of the present application is to be determined by the claims appended hereto, interpreted in accordance with established doctrines of claim interpretation.

What is claimed is:

1. A hollow-core fiber connector assembly comprising:
a Gradient-Index (GRIN) fiber positioned at a front end of the assembly configured to focus and couple light into the hollow-core fiber;
a GRIN stub and a short segment of GRIN fiber, configured to fine-tune a first alignment and focus of the light before entering the hollow-core fiber;
a hollow-core fiber holder (HCF holder) configured to securely hold and align the hollow-core fiber with the GRIN stub;
the hollow-core fiber configured to guide the light through its hollow core, reducing optical losses and dispersion compared to solid-core fibers; and
a metal hub encasing the assembly, providing structural protection and enhancing durability.

2. The hollow-core fiber connector assembly of claim 1, wherein a Single Mode Fiber (SMF) is spliced with the GRIN fiber.

3. The hollow-core fiber connector assembly of claim 1, wherein a second alignment of the GRIN stub with the HCF holder is made through an active coupling process ensuring optimal light transmission through the hollow-core fiber.

4. The hollow-core fiber connector assembly of claim 1, wherein an end face of the GRIN stub is coated with an optical coating to enhance light coupling and improve performance.

5. The hollow-core fiber connector assembly of claim 1, wherein the GRIN fiber, the GRIN stub, and HCF holder are secured in place using an adhesive to maintain precise alignment.

6. The hollow-core fiber connector assembly of claim 1, wherein the metal hub is configured to provide a protective support tube that ensures long-term stability and durability of an optical connection.

7. A method for assembling a hollow-core fiber connector assembly, comprising:
positioning a Gradient-Index (GRIN) fiber at a front end of the assembly to focus and couple light into the hollow-core fiber;
fine-tuning a first alignment and focus of the light using a GRIN stub and a short segment of GRIN fiber before entering the hollow-core fiber;
securely holding and aligning the hollow-core fiber with the GRIN stub using a hollow-core fiber holder (HCF holder);
guiding the light through the hollow core of the hollow-core fiber to reduce optical losses and dispersion compared to solid-core fibers; and
encasing the assembly in a metal hub to provide structural protection and enhance durability.

8. The method according to claim 7, further comprising splicing a Single Mode Fiber (SMF) with the GRIN fiber.

9. The method according to claim 7, further comprising making a second alignment of the GRIN stub with the HCF holder through an active coupling process to ensure optimal light transmission through the hollow-core fiber.

10. The method according to claim 7, further comprising coating an end face of the GRIN stub with an optical coating to enhance light coupling and improve performance.

11. The method according to claim 7, further comprising securing the GRIN fiber, GRIN stub, and HCF holder in place using an adhesive to maintain precise alignment.

12. The method according to claim 7, further comprising configuring the metal hub to provide a protective support tube that ensures long-term stability and durability of an optical connection.

13. A system for a hollow-core fiber connector assembly, comprising:
a Gradient-Index (GRIN) fiber positioned at a front end of the assembly, configured to focus and couple light into the hollow-core fiber;
a GRIN stub and a short segment of GRIN fiber, configured to fine-tune a first alignment and focus of the light prior to entering the hollow-core fiber;
a hollow-core fiber holder (HCF holder) designed to securely hold and align the hollow-core fiber with the GRIN stub;
a hollow-core fiber that guides light through its hollow core, effectively reducing optical losses and dispersion in comparison to solid-core fibers; and
a metal hub encasing the assembly, providing structural protection and enhancing durability.

14. The system of claim 1, further comprising a Single Mode Fiber (SMF) spliced with the GRIN fiber to facilitate optimal light transmission.

15. The system of claim 1, wherein the GRIN stub is aligned with the HCF holder through an active coupling process, ensuring optimal light transmission through the hollow-core fiber.

16. The system of claim 1, wherein an optical coating is applied to the end face of the GRIN stub to enhance light coupling and improve overall performance.

17. The system of claim 1, wherein the GRIN fiber, GRIN stub, and HCF holder are secured in place using an adhesive to maintain precise alignment.

18. The system of claim 1, wherein the metal hub is configured to serve as a protective support tube, ensuring long-term stability and durability of the optical connection by mitigating mechanical stresses and environmental influences.
